(19) United States
(12) Patent Application Publication
(10) Pub. No.: US 2013/0319929 A1
(43) Pub. Date: Dec. 5, 2013

(54) Shower Filter

(71) Applicant: David Aaron Farley, JR., Corona, CA (US)

(72) Inventor: David Aaron Farley, JR., Corona, CA (US)

(21) Appl. No.: 13/485,704

(22) Filed: May 31, 2012

(51) Int. Cl. B01D 29/88

(52) U.S. Cl. CPC B01D 29/88
USPC 210/444

(57) ABSTRACT

A shower filter is disclosed comprising a cap having an input port connectable to shower arm and output port connectable to a showerhead, a filter assembly engageable to and supportable by the cap, and a housing disposed about the filter assembly and engageable to the cap. The housing is disengageable from the cap while the filter assembly remains in engaged to the cap. The filter assembly further includes a fluid dispersal chamber disposed, intermediate the filter assembly an input flow path and the filter assembly output flow path, the fluid dispersal chamber facilitating distribution of water from the filter assembly input flow path throughout the filter assembly annular output flow path and filtering media disposed therealong.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to shower filters. More particularly, the present invention relates to a canister style water filter disposable intermediate the shower arm and the showerhead.

Various devices and systems have been used to treat water used in domestic water systems. Portable water commonly include contaminates and chemicals, such as chlorine, which kills bacteria in the water. Currently, approximately 80% of all potable water systems in the U.S. utilize chlorine as a disinfectant. However, while serving a positive function of eliminating bacteria, and the like, chlorine may be undesirable in drinking water and has a negative effect on human skin and hair. Consequently, it is generally preferable to remove chlorine from drinking water and shower water.

Another characteristic of many portable water systems, particularly water in areas that draw water from certain rivers, is high in mineral content, which contributes to water hardness. Hard water is also undesirable in domestic water systems as insofar as it commonly contributes to scaling, e.g. on glass surfaces, and makes water more difficult to lather, requiring greater amounts of soap, shampoo or the like for showering.

Various types of systems have been used to filter or treat domestic water systems. Whole house systems, also referred to as point of entry systems, treat the water as it enters the house, e.g. to filter or soften the water. Point of use devices, such as shower filters, kitchen sink filters, or refrigerator filters, treat the water at a specific location of the house where the water is used.

Whole house systems are generally effective to remove chemicals or modify water characteristics throughout the house water system. However, while such filtering or treatment may be useful for many uses of water, it may be undesirable for other uses. For example, as noted above, chlorine removal is useful for treating shower water or drinking water. However, it may not be necessary or useful in relation to toilet water, sink water, or swimming pool water, and chlorine removal may facilitate the growth of bacteria or algae within toilets or plumbing of the house. In some cases the algae can contribute to clogging of shower fixtures and other water dispensers.

Whole house water softeners are useful to lower the mineral content of shower water or drinking water. However, many such systems utilize salt to remove the mineral content and soften the water, which introduces a substantial salt content in the water. That may be undesirable for various water uses, such as watering plants, and can cause difficulties in municipal water treatment systems. Accordingly, such whole house systems and water treatment systems commonly have advantages and disadvantages associated with the different uses of domestic water, e.g. drinking water, shower water, toilet water, pool water, watering plants, and fighting bacteria within the house plumbing.

Point of use filtration systems address some of the deficiencies of the whole house systems, and allow selective filtration, to suit the various uses of domestic water. For example, shower filters, kitchen sink filters, and refrigerator filters are useful to remove chlorine from the water at the point of use, while retaining chlorine in the water system to serve as antibacterial additive in the toilet water and pool water, and to mitigate the growth of bacteria and algae in the plumbing.

Shower filtering devices have become increasingly popular and have been implemented in a variety of ways. In-line filters are commonly installed intermediate the shower arm and the showerhead. One such device is the High Output shower filter marketed by Sprite Industries, Inc.

Another type of shower filter is a canister style water filter disposable intermediate the shower arm and the showerhead. Such filters include an input port engageable to the shower arm and an output port engageable to a showerhead. Such filters include a canister, housing a filter assembly, which can be disconnected from the device without the need to disconnect from either the showerhead or shower filter.

One such device is the model number AQ-4100 canister shower filter marketed by Sun Waters Systems under the Aquasana trademark. That device includes canister body, having an integral filter assembly, and a cap having an input that connects to the shower arm and an output that connects to a showerhead. The canister body is threadably engageable to the cap. Replacement of the filter assembly necessities replacement of the integral canister body.

The general architecture of a canister shower filter provides useful advantages, such as allowing for replacement of the filter assembly without disconnecting the cap portion from the shower arm or showerhead. However, the particular construction of existing canister shower filters is subject to undesirable limitations on practical use. For example, while the canister body having an integral filter assembly makes replacement of the assembly relatively simple, the cost of the replacement assembly includes the cost of a replacement canister body, which increases that cost. Moreover, the weight of the filter media makes the canister body filter assembly relatively heavy and can contribute to damage or injury should the canister body filter assembly drop to the shower floor as it is being unscrewed from the cap. Further, because the weight of the filter assembly bears on the threaded engagement between the cap and canister body, any disturbance of the canister body applies stress to the connecting threads and may result in loosening engagement of the canister body from the cap. Also, the canister body filter assembly utilizes a sealing gasket disposed adjacent the mating exterior surfaces of the cap canister body, which is exposed to the shower environment and subject to wear.

Additionally, because engagement of the flow paths between the cap and filter assembly is affected by engagement of the canister body to the cap, care must be take to insure proper sizing and alignment of all connecting surfaces, both in production and in practical installation/removal.

The present invention is intended to address those limitations by providing an improved canister shower filter wherein the filter assembly is separate from the canister body. The filter assembly is engageable to the cap, for fluid tight communication therebetween, independent of engagement of the exterior canister body to the cap.

Further, present invention is intended to define a canister shower filter wherein an engagement of the filter assembly to the cap is implemented through a simple twist and lock type connector that provides a secure fluid tight seal and a reliable mechanical engagement without concern regarding the alignment of the canister exterior body surfaces and the interior connecting surfaces.

Moreover, the present invention is intended to provide a canister shower filter wherein the fluid tight seals facilitating a flow path into and out of the filter assembly are not exposed to the shower environment or the effects of cleaning products used in a shower environment.

These and other features and advantages are implemented in the present invention described more fully below in connection with the accompanying figures and text.

### BRIEF SUMMARY

A shower filter assembly is disclosed comprising a cap having an input port connectable to shower arm and output port connectable to a showerhead, a filter assembly engageable to and supportable by the cap, and a housing disposed about the filter assembly which is separately engageable to the cap. The housing is disengageable from the cap while the filter assembly remains in engaged to the cap.

The filter assembly further defines a first sealing member for sealing the cap input flow path to the filter assembly input flow path, and a second sealing member for sealing the filter assembly output flow path to the cap. Both input and output flow paths between the filter assembly and the cap are sealed upon engagement of the filter assembly to the cap, independent of any engagement between the housing and the cap.

The filter assembly preferably defines an axial input flow path and annular output flow path, with a fluid dispersal chamber disposed within the filter assembly, intermediate an input flow path and output flow path. The fluid dispersal chamber facilitates distribution of water through the annular output flow path. The filter assembly further comprises filtering media disposed along the annular output flow path.

In one embodiment, the housing defines a perforated bottom surface to allow discharge of water leaked into the housing from one of the cap and filter assembly.

The filter assembly may also include a first screen disposed along the output flow path, adjacent the fluid dispersal chamber, the screen separating the filter assembly media and the fluid dispersal chamber to facilitate introduction of water from the fluid dispersal chamber, into the filter assembly annular output flow path.

### BRIEF DESCRIPTION OF THE DRAWINGS

FIG. 1 is a front perspective view of an exemplary shower filter formed in accordance with the present invention;

FIG. 2 is a top view of the shower filter;

FIG. 3 is a side view of the shower filter;

FIG. 4 is a bottom view of the shower filter;

FIG. 5 is an exploded view of the shower filter;

FIG. 6 is an exploded view of the filter assembly alone;

FIG. 7 is a cross sectional view of the filter assembly;

FIG. 8 is a cross sectional view of the shower filter assembly;

FIG. 9 is a bottom view of cap input connector; and

FIG. 10 is a top view of the filter assembly input connector.

### DETAILED DESCRIPTION

Set forth below is a description of presently preferred embodiment of the invention, in connection with the appended drawings. It is to be understood that description and accompanying drawings are not intended to be the only possible embodiment of the invention. As it can be recognized by those skilled in the art, the novel and inventive features of the invention may also be implemented in other embodiments which are not disclosed or described herein.

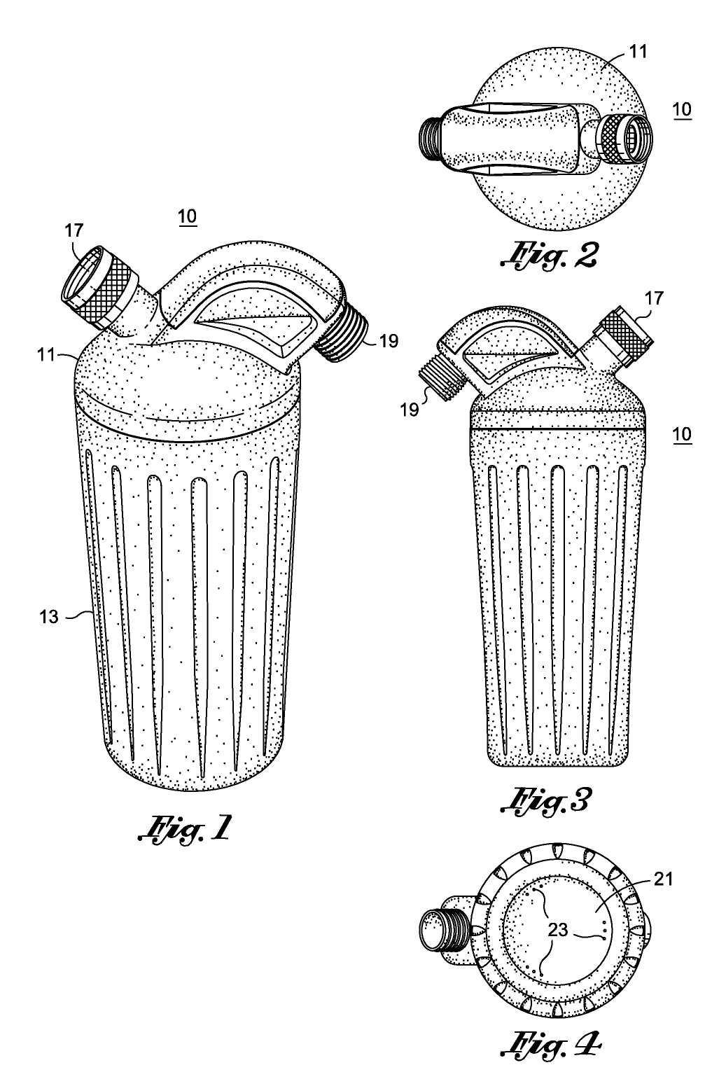

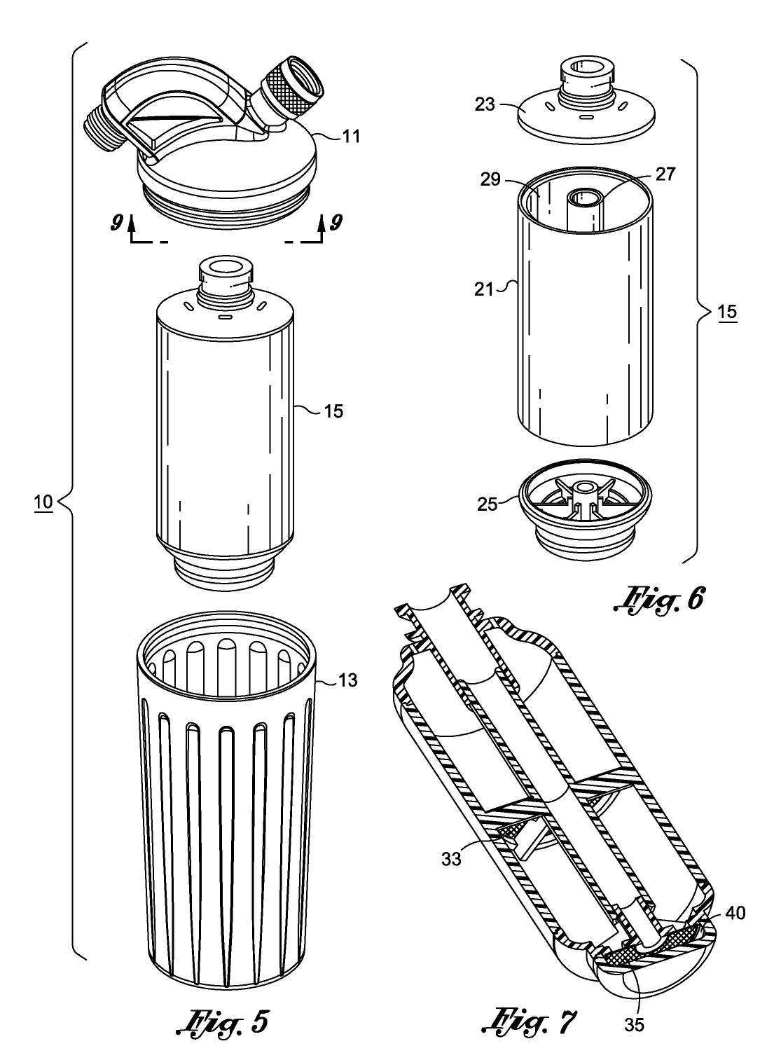

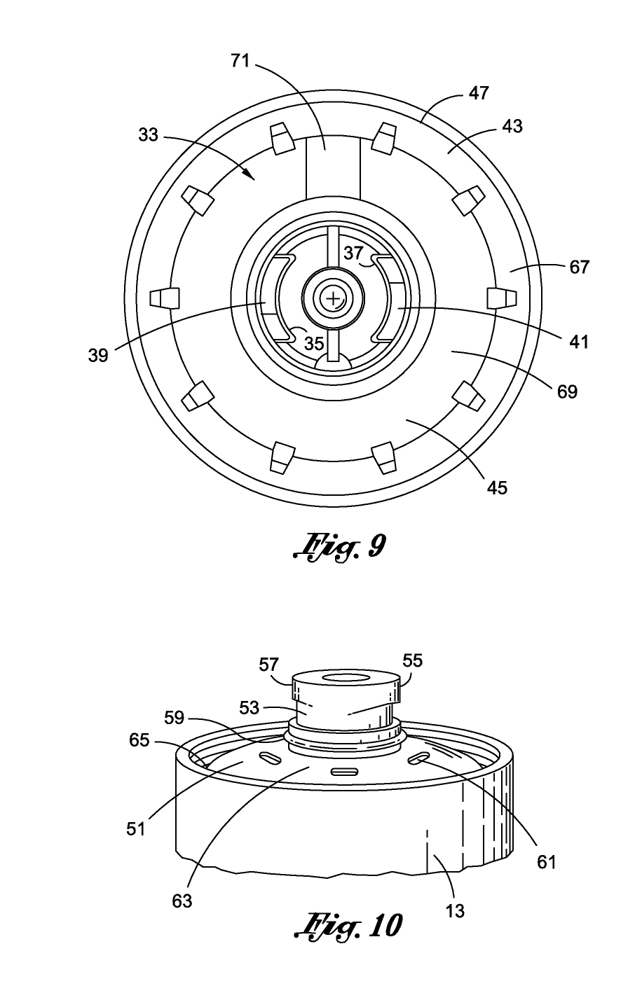

Referring to the drawings, the FIGS. 1-4 illustrate the exterior configuration of a canister shower filter constructed in accordance with the present invention. As shown therein, the shower filter 10 includes a cap 11 and a housing 13. As shown in FIGS. 5 and 8, the cap 11 is threadably engageable to the housing 13.

Cap 11 includes input port 17 and output port 19. The input port 17 is threadably engageable to the shower arm extending from the shower wall. The output port 19 is threadably engageable to a showerhead (not shown) for directing water into the shower area.

As shown at FIG. 4, the housing 13 includes a bottom portion 21 which defines a plurality of drain apertures 23. The drain apertures 23 allow water that enters the housing 13, e.g. through the interface between cap 19 and canister body 13, or otherwise, to drain freely from the canister body.

FIG. 5 illustrates an exploded view of the shower filter 10, showing the cap 11, the filter assembly 15, and the housing 13. As described more fully below, the filter assembly 15 is engageable to the cap 11 independent of engagement between the cap 11 and the housing 13.

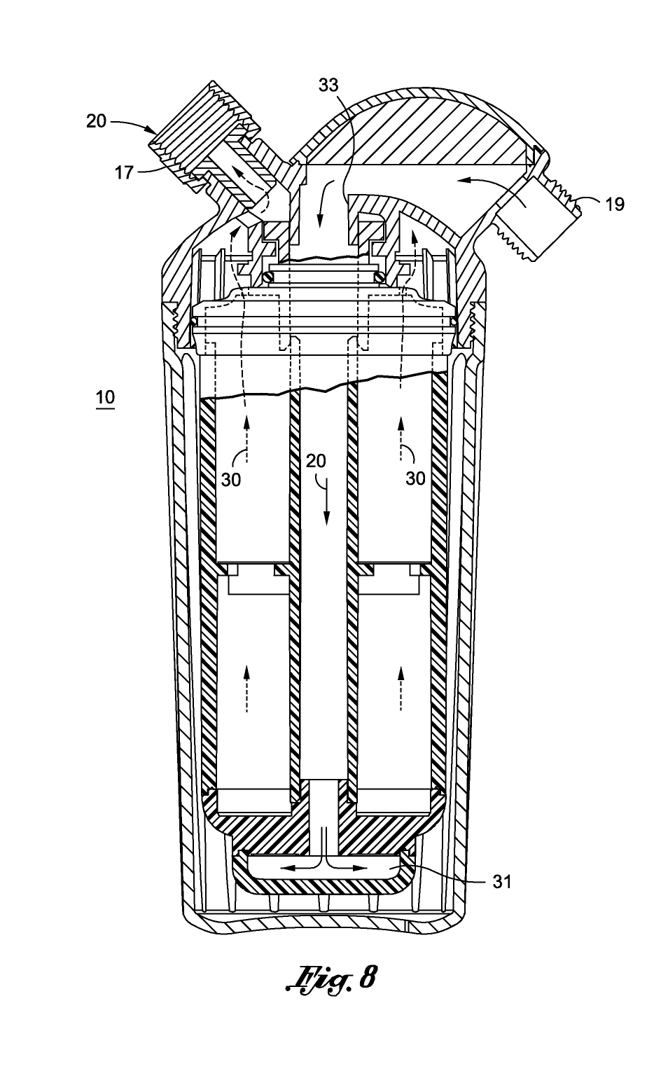

FIG. 6 is an exploded view of the filter assembly 15. The assembly 15 includes a filter assembly body 21, a top portion 23 and a body portion 25. In use, the water filtering media, such as a copper/zinc media, disposed within the filter assembly body 21 to remove chlorine and containments from the water flowing through the filter body 21.

Filter assembly top portion 23 is engaged to filter assembly body 21. The top portion 23 also defines a filter input connector 53 which is mechanically engageable to a cap input connector 33 to place the filter assembly and the cap in fluid communication, as described in more detail below. Filter assembly 15 further defines bottom portion 25 extending from the filter assembly body 21. The bottom portion 25 defines a fluid dispersal chamber 40, beneath screen 40, which facilitates distribution of water from the filter assembly axial input flow path 20 to the filter assembly annular output flow path 30. As a result, the flow of water along the filter assembly output flow path 30 is more evenly distributed about the media disposed therealong. Accordingly, water flows into the shower filter 10 from the shower arm into the cap input port 17 and through the filter assembly central conduit 27 to the filter assembly output flow path (through an annular chamber 31 shown in FIG. 8), to cap output port 19, and is discharged through the showerhead (not shown). The filter assembly 15 may also include screens 33, 35, as shown at FIG. 7, which are useful to maintain the filter media in place within the filter assembly body 21.

FIG. 8 provides a cross sectional view of the shower filter 10, illustrating the input flow path 20 and output flow path 30. The input flow path 20 enters the shower filter assembly at cap input port 17 and is channeled through the cap input connector 33, and through apertures 35, 37. The cap input connector 33 also defines flanges 39, 41, which facilitate mating engagement with the filter assembly 15. The cap input connector 33 further defines a cylindrical extension 47, having a lower surface 43. The cylindrical extension 47 surrounds fluid chamber 45. The lower surface 43 engages with the filter assembly top portion 33, as shown in more detail at FIG. 10, to form a fluid tight seal between the cap connecting portion 33 and the filter assembly connecting portion 53.

FIG. 10 illustrates a portion of the filter assembly 15, which connects to the cap 11. As shown therein, filter assembly input connector 53 extends through the filter assembly top portion 51 and defines a plurality of flanges that outwardly extending flanges 55, 57, which are rotatable into a locking engagement with flanges 39, 41 of the cap input connector 33. In practice, after cap 11 is connected with the shower arm, the filter assembly input connector 53 is aligned with the cap input connector 33 and rotated approximately 90° to effect one handed, twist-locking engagement/disengagement therebetween, i.e. only a single hand is needed to securely engage/disengage the filter assembly and the cap. As a result of that engagement, the lower surface 43 of cap cylindrical extension 47 is seated on the top 21 of filter assembly 15, and the cylindrical extension 47 is sealed against filter assembly gasket 59, thus communicating fluid tight input flow path 20 from the cap 11 into the filter assembly 15.

Engagement of the filter assembly flanges 55, 57, to the cap flanges 39, 41, also forms a fluid tight seal to communicate output flow path 30 from the filter assembly 15 to the cap 11. Referencing FIG. 10, filter assembly top portion 51 defines a plurality of apertures 61, 63, through which filtered water flows out of filter assembly 15. The filter assembly top portion 51 further defines a sealing gasket 65, which upon rotation of the filter assembly as described above, is engageable to lip 67 of the cap, shown at FIG. 9, to define a fluid tight annular chamber 69 intermediate opposing surfaces of the filter assembly 15 and the cap 11, thus communicating fluid tight output flow path from the filter assembly 15 to the cap 11.

As shown in FIG. 9, the cap defines aperture 71 which communicates an output flow path from filter assembly apertures 61 (FIG. 10) and chamber 69 to cap output port 19.

Accordingly, engagement of the cap connecting portion to the filter assembly connecting portion mechanically secures the filter assembly to the cap, fully supporting the filter assembly, while also sealing and segregating the input and output flow paths between the cap and filter assembly.

As described above, the input flow path flows axially through the filter assembly to the bottom portion of the filter assembly, where it merges with the output flow path which travels through the filtering media disposed in the annular chamber.

Once the filter assembly is connected to the cap, the assembly is fully functional. The housing 13 is threadably engageable to the cap 11 and serves to insulate the filter assembly/cap connecting portions from exposure to the shower environment and mechanical disturbances that may adversely affect the integrity of the connection between the filter assembly 15 and the cap 11.

What is claimed is:

1. A shower filter assembly comprising:
a cap having an input port, an output port, and a cap lower edge surface, the cap defining a cap input flow path, extending from the cap input port, and a cap output flow path, extending to the cap output port, the cap further defining a cap input connector in fluid communication with the cap input flow path;
a filter assembly engageable to and supported by the cap, the filter assembly defining an axial input flow path and an annular output flow path; and
the filter assembly further defining a filter assembly input connector in fluid communication with the filter assembly input flow path, the filter assembly input connector being configured for rotatable, fluid tight engagement with the cap input connector, to place the cap in fluid communication with the filter assembly.

2. The shower filter as recited in claim 1 wherein the cap input connector defines a substantially cylindrical cap central extension and a pair of cap engaging flanges extending inwardly therefrom.

3. The shower filter as recited in claim 2 wherein the filter assembly input connector defines a substantially cylindrical filter assembly central extension and a pair of filter assembly engaging flanges extending outwardly thereform.

4. The shower filter as recited in claim 3 wherein the filter assembly engaging flanges and cap engaging flanges are rotatably engageable to secure the filter assembly to the cap and to define a fluid tight seal between the cap and the filter assembly.

5. The shower filter as recited in claim 4 further including a housing removably disposable about the filter assembly, the housing being rotatably engageable to the cap.

6. The shower filter as recited in claim 6 wherein the filter assembly is engageable to the cap, independent of engagement of the housing to the cap.

7. The shower filter as recited in claim 6 wherein the housing is engageable to the cap, independent of engagement of the filter assembly to the cap.

8. The shower filter as recited in claim 7 wherein the filter assembly input connector further defines a first sealing gasket disposed thereabout, the first sealing gasket facilitating a fluid tight seal between the cap input flow path and the filter assembly input flow path, in response to engagement of the cap engaging flanges and the filter assembly engaging flanges.

9. The shower filter as recited in claim 8 wherein the filter assembly further defines a top portion having a plurality of filter assembly output apertures extending thereabout, the output apertures being in fluid communication with the filter assembly output flow path, and a second sealing gasket disposed about the periphery of the filter assembly top portion, the second sealing gasket facilitating a fluid tight seal between the filter assembly output flow path and the cap output flow path, in response to engagement of the cap engaging flanges and the filter assembly engaging flanges.

10. The shower filter as recited in claim 9 wherein, upon engagement of the cap engaging flanges and the filter assembly engaging flanges, the filter assembly central extension is received within the cap central extension.

11. The shower filter as recited in claim 9 wherein the filter assembly includes water filtering media disposed within the filter assembly along the filter assembly at output flow path.

12. The shower filter as recited in claim 11 wherein the filter assembly further includes a bottom portion defining a fluid dispersal chamber disposed intermediate the filter assembly input flow path and the filter assembly output flow path.

13. The shower filter as recited in claim 12 wherein the fluid dispersal chamber facilitates distribution of fluid from the input flow path throughout the filter assembly annular output flow path and the filtering media disposed therealong.

14. The shower filter as recited in claim 13 wherein the filter assembly includes a first screen disposed intermediate the filter assembly output flow path and the fluid dispersal chamber, the first screen separating the filtering media and the fluid dispersal chamber

15. The shower filter as recited in claim 9 wherein the cap and the housing define engageable first and second threaded surfaces, respectively.

16. The shower filter as recited in claim 15 wherein upon engagement of the cap and housing the first and second sealing gaskets are disposed interior to the first and second threaded surfaces.

17. The shower filter as recited in claim 16 wherein the housing defines a lower surface having a plurality of drain apertures formed therein.

18. The shower filter as recited in claim 9 wherein the filter assembly is rotatable approximately 90° to effect one handed, twist-locking engagement/disengagement with the cap.
